(19) United States
(12) Patent Application Publication
(10) Pub. No.: US 2003/0177175 A1
(43) Pub. Date: Sep. 18, 2003

(54) Method and system for display of web pages

(76) Inventors: Dale R. Worley, Waltham, MA (US); Kenneth A. Giusti, Upton, MA (US); Gregory O. Bruell, Carlisle, MA (US)

Correspondence Address: Hunton & Williams, Suite 1200, 1900 K Street, N.W., Washington, DC, 20006-1109, US

(21) Appl. No.: 10/132,153

(22) Filed: Apr. 26, 2002

Related U.S. Application Data
(60) Provisional application No. 60/286,369, filed on Apr. 26, 2001.

(51) Int. Cl. G06F 15/16

(52) U.S. Cl. 709/203; 709/218; 709/228

(57) ABSTRACT

A method and system enables browsers to redisplay or refresh pages periodically while limiting retransmission of data to changing dynamic portions (data fields, dynamic content) of page files and avoiding retransmission of static portions of page files. Additional aspects include: a method of detecting when the infrequently-changing ‘skeleton’ parts of the page file have changed, thus avoiding having to re-transmit those parts with every update of the frequently-changing parts; a method of integrating the specification of add-on GUI ‘modules’ with ordinary web content written in HTML, thus reducing the effort needed to use the modules; and a method for a browser to instruct a web server to provide a specially modified version of a web page file. This reduces the amount of information that needs to be transmitted to refresh web pages periodically and facilitates incorporating defined GUI modules into HTML web pages.

### CROSS REFERENCE TO RELATED APPLICATIONS

This application claims the benefit of United States provisional patent application Serial No. 60/286,369 filed Apr. 26, 2001, the disclosure of which is incorporated herein by reference.

### FIELD OF THE INVENTION

Generally, the present invention relates to graphical user interfaces (GUIs) which present information in one or a combination of textual, graphical, audio, video and other multi-media forms. Often the information presented is made up of components or individual data files or groups which are separately updated and often combined to result in a complete presentation to the user. GUIs may, among other things, control, manage, configure, monitor and diagnose software and hardware applications and devices. GUIs are often embedded into systems or devices and are employed in systems made available to a plurality of users over public and private distributed networks or internets, such as the Internet. GUIs are often designed for use with certain protocols or architectures, such as the WWW (World Wide Web—hypertext objects and links HTML/HTTP) client/server model, or other “webs” of interconnected document objects. The invention also relates to methods and systems adapted to develop, configure, reconfigure or otherwise manipulate GUIs in a desired manner to conform to designer or user needs or wishes.

### BACKGROUND

There is a wide variety of known GUIs and methods for developing GUIs are well known. As increasing amounts of data in increasingly sophisticated and dense packets or other units are made available to users at sites on distributed networks, bandwidth and speed of communication become increasingly critical to the overall user experience and enjoyment. Accordingly, developers are continuously looking for ways to enhance the presentation and user enjoyment of GUIs. Often, users want automatically “updating” web pages. These pages display some information that changes (usually over periods of seconds or minutes), e.g., stock quotes, scores, interactive user comments, etc. Users want these pages to be redisplayed periodically without user intervention. Most browsers have features that allow a page to be marked so that the browser will re-request and re-display the entire contents and presentation, such as graphics, of the page periodically. These techniques have the disadvantage that the browser will request a new copy of the entire contents of the page for redisplay, and so the entire contents of the page must be transmitted each time from the server to the browser, even if most of the page does not change.

Some known methods or techniques have been devised to avoid or lessen the frequency of unnecessarily requesting and transmitting of non-changing or non-critical data. For instance, with respect to refreshing web pages, in one known system, when the browser wishes to display a web page to a user, it retrieves a set of files from a server. One file contains the HTML, which is the text of the page together with indications of where graphics are to be inserted into the display of the page. The remaining files are the graphics files that generate images that the browser inserts into the displayed page. All of the files are stored in a local cache. When the page is to be refreshed, the system checks with the server to see if any of the files have been replaced by newer versions. If newer versions are available, those are retrieved and used for re-displaying the page. For any file that does not have a newer version, the cached copy of the file is used, saving the cost of transmitting a copy of the file from the server again. An example of such a system is described in U.S. Pat. No. 6,094,662 (Hawes).

A technique used in some such systems is to assume that the graphics files have not changed, and, based on such an assumption, avoid having the browser check the server to determine if the graphics files have in fact changed. In so doing, this method decides which files are cacheable by file names or data types, rather than by examining the markup that the user has specified to generate the file contents. Further, this method classifies which parts of the page are static by classifying each file as either cacheable or non-cacheable, rather than classifying fragments of files. The classification as to which items are cacheable is done by the browser.

### SUMMARY OF THE INVENTION

The present invention provides a method and system that enables browsers to redisplay or refresh pages periodically while permitting servers to limit retransmission of data to the changing portions (data fields, dynamic content) of the files of pages to the browsers.

Alone and in combination, the present invention includes the following features: (1) a method of periodically revising the changing parts of a web page file without re-transmitting the entirety of the page file from the web server to the browser, (2) a method of detecting when the infrequently-changing ‘skeleton’ parts of the page file have changed, thus avoiding having to retransmit those parts with every update of the frequently-changing parts, (3) a method of integrating the specification of add-on GUI ‘modules’ with ordinary web content written in HTML, thus reducing the effort needed to use the modules, and (4) a method for a browser to instruct a web server to provide a specially modified version of a web page file.

One advantage of the present invention is to reduce the amount of information that needs to be transmitted in order to refresh web pages periodically.

Another advantage of the present invention is to make it easier for the user to incorporate defined GUI modules into HTML web pages.

Yet another advantage of the present invention is to allow the web server to deliver modified versions of web page files for use in the other methods.

The present invention may be implemented in GUI development kits, such as included in embedded web servers, and may be incorporated into products that include a web-based interface (e.g., for configuring a DSL modem). The present invention may be included in a software package designed to enable a user to create a web-based interface. As such, it might be included in any ISOS-type product or as an auxiliary part of any software system.

In contrast with prior art methods and systems, the following are examples of ways in which the present invention more efficiently and effectively updates web page file display data, for instance: 1) the cacheable and non-cacheable portions or fragments of the file are distinguished by markup which is part of the document or page file, as opposed to distinguishing based on the names or data types of page files; 2) the distinguishing of the cacheable and non-cacheable portions of a file is done by the server, which then in effect informs the browser or “client” as to which is cacheable and which is not; 3) non-cacheable portions are re-retrieved from the server by the client, rather than first testing each non-cacheable portion to see if it has changed before re-retrieving it; and 4) the document is composed of cacheable portions and non-cacheable portions, the cacheable portions are unchanging, whereas the non-cacheable portions are specified by executable code, which are executed at the time that the client requests the portion to generate the content that is transmitted to the client.

In one embodiment, the present invention provides a method for refreshing the display of a web page on a client computer having a memory, a browser and a display, the client receiving page files associated with the displayed web page from a server connected to the client computer via a communication link over a distributed network. The method comprises the steps of: requesting from the client computer a web page from the server; obtaining by the server page files associated with the requested web page; modifying by the server at least one page file comprising static and dynamic data fragments into a skeleton file comprising static data and a dynamic data file representing dynamic data; transmitting by the server to the client at least the skeleton file and the dynamic data file; adapting by the client browser at least the skeleton file and the dynamic data file to display the web page associated with the modified page file; and the server retransmitting the dynamic data file while not retransmitting the skeleton file to the client to refresh the displayed web page with changed dynamic data.

In another embodiment, the invention provides, in a distributed network comprising at least one server and at least one client computer in electrical communication with the at least one server via a communications link, a system for modifying page files associated with web pages for display at the client computer to achieve more efficient refreshing of displayed web pages. The system includes a refresh module stored on a memory accessible by a server and executable by a server processor. The server adapted to receive a request from a client computer for a web page to be displayed at the client computer, the server obtaining at least one page file associated with the web page and providing the page file to the refresh module, the refresh module adapted to modify the page file to generate a skeleton file comprising static content and placeholders for dynamic data, and a dynamic data file comprising data identified to change over time. The server transmits the skeleton file and the dynamic data file to the client. The client computer includes an input for receiving the skeleton file and the dynamic data file from the server over the communications link. The client computer also includes a browser adapted to combine the skeleton file with the dynamic data file in generating and displaying the requested web page. The system is adapted to subsequently retransmit the dynamic data file while not retransmitting the skeleton file to refresh the dynamic data associated with the requested and displayed web page.

In yet another embodiment, the invention is used in a distributed network comprising at least one server having a processor and a memory and being in electrical communication with at least one client computer over a communications link. The invention provides a computer readable medium having a set of executable instructions stored on the server memory and being machine readable by and adapted to manipulate the server processor to cause the server to perform a plurality of functions. The functions include: obtaining from a memory at least one page file associated with a web page requested by the client, the page file comprising both static and dynamic data; modifying the page file to generate a skeleton file comprising static data and having markers for dynamic data associated with the web page; modifying the page file to generate a dynamic data file comprising dynamic data associated with the web page; recognizing a request for updated dynamic data; and retransmitting the dynamic data file to the client to refresh dynamic data of the web page displayed at the client.

In yet another embodiment, the present invention is used in a distributed network comprising a first computer and having stored therein an HTML file comprising static data and dynamic data, the first computer being in electrical communication with a second computer over the network and transmitting thereto data representative of the HTML file for displaying a web page at the second computer. The invention provides a system for updating the dynamic data portion of the HTML file without updating the static portion of the HTML file cached at the second computer to achieve more efficient refreshing of the displayed web page. The system includes a refresh module stored and executable at the first computer and adapted to modify the HTML file to generate a skeleton file comprising static content and placeholders for dynamic data, and a dynamic data file comprising data identified to change over time. The first computer being adapted to transmit the skeleton file and the dynamic data file to the second computer and the second computer being adapted to receive the skeleton and dynamic data files. The system includes a browser operable on the second computer and being adapted to combine the skeleton file with the dynamic data file to generate and display a web page associated with the HTML file. The first computer subsequently retransmits the dynamic data file, while not retransmitting the skeleton file, to refresh dynamic data associated with the HTML file and the displayed web page.

In another embodiment, the present invention provides a method for refreshing the display of a web page on a client computer having a memory, a browser and a display, the client receiving page files associated with the displayed web page from a server connected to the client computer via a communication link over a distributed network. The method includes the steps of: requesting from the client computer a web page from the server; obtaining by the server page files associated with the requested web page; modifying by the server at least one page file comprising static and dynamic data fragments into a skeleton file comprising static data and a dynamic data file representing dynamic data; transmitting by the server to the client at least the skeleton file and the dynamic data file; processing by the browser at least the skeleton file and the dynamic data file to display the web page associated with the modified page file; subsequently retransmitting by the server a refreshed dynamic data file while not retransmitting the skeleton file to the client to refresh the displayed web page with updated dynamic data; determining that a change in the content of the skeleton file has occurred; and transmitting by the server to the client a revised skeleton file representing the change in content for replacing the skeleton file and for storing the revised skeleton file at the client.

In yet another embodiment, the present invention, in a distributed network comprising at least one server and at least one client computer in electrical communication with the at least one server via a communications link, provides a system for modifying page files associated with web pages for display at the client computer to achieve more efficient refreshing of displayed web pages. The system includes a refresh module stored on a memory accessible by a server and executable by a server processor, the server receiving a request from a client computer for a web page to be displayed at the client computer, the server obtaining at least one page file associated with the web page and providing the page file to the refresh module, the refresh module adapted to modify the page file to generate a skeleton file comprising static content and placeholders for dynamic data, and a dynamic data file comprising data identified to change over time. The server transmits the skeleton file and the dynamic data file to the client. The client computer includes an input for receiving the skeleton file and the dynamic data file from the server over the communications link. The client further includes a browser adapted to combine the skeleton file with the dynamic data file in generating and displaying the requested web page. The system is adapted to subsequently retransmit the dynamic data file while not retransmitting the skeleton file to refresh the dynamic data associated with the requested and displayed web page. The system being further adapted to determine a change in the content of the skeleton file and to transmit to the client a revised skeleton file representing the change in content for replacing the skeleton file and for storing the revised skeleton file at the client.

In another embodiment, the present invention, in a distributed network comprising a server serving an XHTML file to a client computer over a communications link, the client comprising a browser and GUI, provides a method of converting the XHTML file into an HTML file for displaying a requested web page. The method includes the steps of: assigning, using the namespace mechanism in XML, a namespace to mark at least one GUI HTML module contained in the XHTML file; parsing the XHTML file to locate GUI HTML module; and assembling the HTML file by the browser, including the GUI HTML module, to display a requested web page.

In yet another embodiment, the present invention, in a distributed network having a server serving an XHTML file to a client computer over a communications link, the client having a browser and GUI, provides a method of converting the XHTML file into an HTML file for displaying a requested web page. The method comprising the steps of: assigning, using the namespace mechanism in XML, a namespace to mark at least one GUI XML element contained in the XHTML file; parsing the XHTML file to locate a GUI XML element; converting the GUI XML element into an HTML template which instructs the browser to perform actions intended by the GUI XML element; replacing the GUI XML element within the XHTML file with the HTML template; and displaying the resulting HTML file by the browser, resulting in displaying the requested web page.

### BRIEF DESCRIPTION OF THE DRAWINGS

The present invention can be understood more completely by reading the following Detailed Description of the Invention, in conjunction with the accompanying drawings, in which:

FIG. 1 is a flow chart illustrating one embodiment of an enhanced web page processing and displaying method incorporating the present invention;

FIG. 2 is a flow chart illustrating a variation of the correlating step or function of the inventive embodiment of FIG. 1; and

FIG. 3 is a schematic diagram illustrating a client/server network incorporating the present invention.

### DETAILED DESCRIPTION OF THE INVENTION

The following description is intended to convey a thorough understanding of the invention by providing a number of specific embodiments and details involving enhanced processing and display of web pages. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

One aspect of the present invention involves updating a web page without re-transmitting unchanging or rarely changing (static) data or portions of the one or more page files that make up the web page. As used herein, the term “static” shall mean and is used to refer to unchanging data or content and rarely changing data or content, that is data or content that may change over a period of time much greater in magnitude than that of dynamic data or content, which changes much more frequently. Accordingly, the term static, as used herein and in the claims, is not to be interpreted to require that the data, content or item so qualified be unchanging in absolute terms. A web page may consist of a single file, such as an HTML file that may contain both static and dynamic content. Often, web pages will be comprised of multiple files that are assembled at the browser for display as the web page. For instance, a web page may be comprised of an HTML page (with pointers to graphic images/files) and graphic files. The graphic files typically do not change, or at least infrequently, and may be considered static. The HTML web page file may consist of, for example, static text content and dynamic text or data content.

To present the most up to date information, it is often advantageous to have automatically “updating” or “refreshing” web pages. Typically, these pages display some data or information that changes (usually over periods of seconds or minutes). Users want the page to be redisplayed or refreshed periodically without user intervention. Most browsers have features that allow a page to be marked so that the browser, most often associated with the client-side, will re-request and re-display it periodically. These techniques have the disadvantage that the browser will request a new copy of the entire contents of the page for redisplay, and so the entire contents of the page (all files and all portions, both static and dynamic, of all files) must be transmitted each time from the server to the browser, even if most of the page does not change.

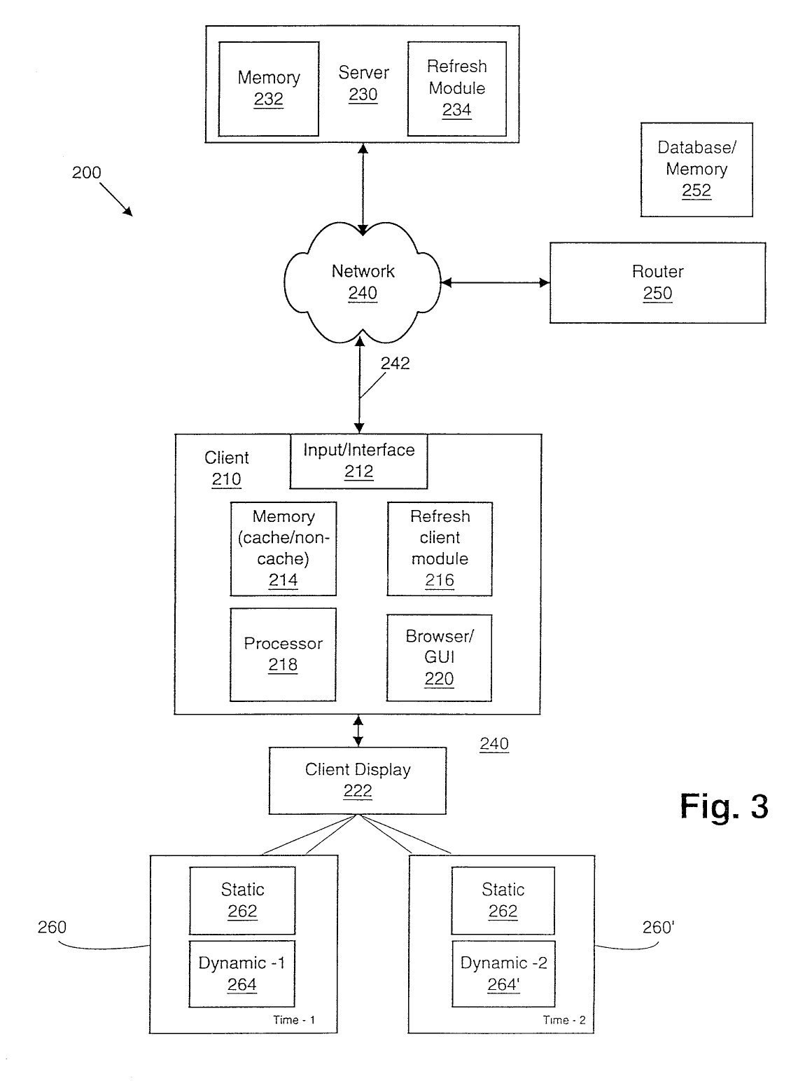

One novel aspect of the present invention provides a method and system that enables the browser to redisplay the page periodically while permitting the server to only retransmit the changing portions or fragments (data fields, dynamic content) of the page file(s) to the browser. In one manner, the server, such as server 230 of FIG. 3, converts an original page file having both changing and non-changing portions or fragments into separate files based on the static or dynamic nature of the content. The original file is modified to create a “skeleton” file comprised of static content and pointers, placeholders, links or addresses for dynamic data found in the original file. The server creates a separate dynamic data file which includes or represents the dynamic content of the original file. Both files are transmitted from the server to the client browser, such as browser 220 of client 210 of FIG. 3, which reassembles the dynamic data file with the skeleton file for display of the web page. Thereafter, to display and refresh the web page, or at least that portion of the converted page file that is part of the web page, the browser may simply request the dynamic data file for retransmission from the server or the server will push only the dynamic data file of the page file to the browser. This is described in more detail hereinbelow with exemplary original, skeleton and data files.

In illustrating this aspect of the present invention, it is helpful to consider the following exemplary sample document or page file:

<!DOCTYPE HTML PUBLIC “-//w3c//DTD HTML 4.01//EN”>
<html>

<head>

<title>Document A</title>
<EMWEB_REFRESH START INTERVAL=“2000” />

</head>
<body>

<h1>Document A</h1>
These links shouldn't work in prototyping . . . <br/>
<a href=“index.html”>index.html/<a>
<br />
<emweb_macro id=‘ewxDate’/>
<table>

<tr><td>Total</td>

<td align=‘right’><emweb_macro id=‘RANDOM6’ param=‘1’/></td>

</tr>
<tr><td>Local Destination</td>

<td align=‘right’><emweb_macro id=‘RANDOM6’ param=‘2’/></td>

</tr>
<tr><td>Format Errors</td>

<td align=‘right’><emweb_macro id=‘RANDOM6’ param=‘3’/></td>

</tr>
<tr><td>Checksum Errors</td>

<td align=‘right’><emweb_macro id=‘RANDOM6’ param=‘4’/></td>

</tr>

</table>

</body>

</html>

This is an example of a document or page file “the sample page file” to be served by a server, such as for example the proprietary EmWeb™ server of Virata Corporation. In keeping with and in further describing the usefulness of the present invention, additional descriptions of uses and configurations of embedded web server GUIs, such as EmWeb, can be found in U.S. Pat. No. 5,973,696 (Agranet et al.), assigned to the assignee of the present invention, which is incorporated herein by reference. Further illustrative embodiments and descriptions of embedded web server GUIs in which the present invention may be employed are disclosed in U.S. patent applications Ser. No. 09/322,382 and Ser. No. 60/023,373, both entitled Embedded Web Server, and U.S. patent application Ser. No. 60/108,321, entitled Embedded Graphical User Interface Using A Markup Language With Dynamic Elements Using a Programming Language, all of which are also assigned to the assignee of the present invention and are incorporated herein by reference.

Again referring to the above sample page file, the “<emweb_macro . . . >” tags are directions for the EmWeb server to insert dynamic content values at the indicated locations. When the browser requests this sample page file from the server, for each <emweb_macro> tag the server will execute program code to obtain a character string, which the server will insert into the outgoing page file in place of the <emweb_macro> tag. Every time the page file is sent to a browser, the code will be executed, and (potentially) every service of the page file will be different. In this example, the remainder of the page file is static content, that is, it will be sent unchanged in the response to every browser request. As discussed above, retransmission of unchanging data associated with the sample page file is an unessential use of system resources.

In one manner, the invention provides a method to direct the server to convert the original sample page file and to send two modified file versions of the sample page file, which the browser reassembles to produce the document to be displayed. One version of the sample page file is the “skeleton” file, and contains only the static content with placeholders or the like for dynamic content. The other version is the “data” file, and contains or represents only the dynamic content. As an initial matter, both the skeleton and data files are transmitted to the browser for assembly and display. Subsequently, upon request from the browser, the server can automatically generate and send either of the skeleton and data files, because the information needed to construct them is present in the original file transmission. Since the skeleton file is generally unchanging, the browser need only request it once. The browser may obtain a new copy of the data file each time it updates the display. In this manner, the client browser does not update the static content, such as content 262 of page display 260 of FIG. 3, while refreshing the dynamic content, such as dynamic content 264 of page display 260, with updated dynamic content, such as dynamic content 264′ of page display 260′.

The skeleton file of the sample page file, as illustrated below, may be an XML document file containing the static content as quoted strings (between “<![CDATA[” and “]]>”, shown italicized) and markers for the location of dynamic content (as <dynamic>elements).

<?xml version=“1.0”?>
<skeleton xmlns=“http://www.emweb.com/xml/skeleton.dtd”>
<![CDATA[<!DOCTYPE HTML PUBLIC “-//w3c//DTD HTML 4.01//EN”>
<html>

<head>

<title>Document A</title>
<EMWEB_REFRESH START INTERVAL=“2000”/>

</head>
<body>

<h1>Document A</h1>

These links shouldn't work in prototyping . . . <br />

<a href=“index.html”>index.html</a>
<br />
]]><dynamic ns=“emweb” id=“ewxDate”/><![CDATA[

<table>

<tr><td>Total</td>

<td align=‘right’>]]><dynamic ns=‘emweb’ id=‘RANDOM6’

param=‘1’/><![CDATA[</td>

</tr>
<tr><td>Local Destination</td>

<td align=‘right’>]]><dynamic ns=‘emweb’ id=‘RANDOM6’

param=‘2’/><![CDATA[</td>

</tr>
<tr><td>Format Errors</td>

<td align=‘right’>]]><dynamic ns=‘emweb’ id=‘RANDOM6’

param=‘3’/><![CDATA[</td>

</tr>
<tr><td>Checksum Errors</td>

<td align=‘right’>]]><dynamic ns=‘emweb’ id=‘RANDOM6’

param=‘4’/><![CDATA[</td>

</tr>

</table>

</body>

</html>
]]></skeleton>

Skeleton file format may be difficult to read. As a general rule, in XML, everything between “<![CDATA[” and “]]>” is quoted text; the CDATA construction forms a quoted string. (The contents of the CDATAs are italicized in the above example.) If the contents of CDATAs are replaced with “ . . . ” the overall structure of the skeleton document as an XML document is as follows:

<?xml version=“1.0”?>
<skeleton xmlns=“http://www.emweb.com/xml/skeleton.dtd”>
<![CDATA[. . .
]]><dynamic ns=“emweb” id=“ewxDate”/><![CDATA[
. . .
]]><dynamic ns=‘emweb’ id=‘RANDOM6’ param=‘1’/><![CDATA[
. . .
]]><dynamic ns=‘emweb’ id=‘RANDOM6’ param=‘2’/><![CDATA[
. . .
]]><dynamic ns=‘emweb’ id=‘RANDOM6’ param=‘3’/><![CDATA[
. . .
]]><dynamic ns=‘emweb’ id=‘RANDOM6’ param=‘4’/><![CDATA[
. . . ]]></skeleton>

If everything except contents of CDATAs is replaced with “ . . . ”, the overall structure of the static content contained in the skeleton file is as follows:

. . . <!DOCTYPE HTML PUBLIC “-//w3c//DTD HTML 4.01//EN”>
<html>

<head>

<title>Document A</title>
<EMWEB_REFRESH START INTERVAL=“2000” />

</head>
<body>

<h1>Document A</h1>

These links shouldn't work in prototyping . . . <br />
<a href=“index.html”>index.html</a>
<br />
. . .

<table>

<tr><td>Total</td>

<td align=‘right’>. . . </td>

</tr>
<tr><td>Local Destination</td>

<td align=‘right’>. . . </td>

</tr>
<tr><td>Format Errors</td>

<td align=‘right’>. . . </td>

</tr>
<tr><td>Checksum Errors</td>

<td align=‘right’>. . . </td>

</tr>

</table>

</body>

</html>
. . .

In this example, the skeleton page file contains all of the static content of the document as quoted character strings, and each <emweb_macro> is replaced with a <dynamic . . . > tag. This <dynamic> tag is a placeholder, pointer or the like that indicates that dynamic content goes in that location. The attributes of the <dynamic> tag, “ns”, “id”, and “value”, identify which piece of dynamic content goes in which location—the <dynamic> tag stands in for an <emweb_macro> with the same “ns”, “id”, and “value” attributes. The default value of the “ns” attribute is “emweb”. The <emweb_macro> tags in the original page were written with the “ns” attribute omitted, and, in this example, the <dynamic> tags were generated automatically by the EmWeb server, which included the “ns” attributes.

The following represents the data file, or dynamic content, version of the original sample page file:

<?xml version=“1.0”?>
<xmlout xmlns=“http://www.emweb.com/xml/XMLout.dtd”>
<object ns=‘emweb’ id=“ewxDate”>Mon, 05 Feb 2001 15:46:14 GMT</object>
<object ns=‘emweb’ id=‘RANDOM6’ param=‘1’>1 345</object>
<object ns=‘emweb’ id=‘RANDOM6’ param=‘2’>173 768</object>
<object ns=‘emweb’ id=‘RANDOM6’ param=‘3’>432</object>
<object ns=‘emweb’ id=‘RANDOM6’ param=‘4’>12 376</object>
</xmlout>

In this example, the data file version of the sample page file is entirely in XML. The outermost element is <xmlout>. It contains a series of <object> elements. The dynamic content values themselves are contained in the <object> elements. In this exemplary case, the first data item is “Mon, 05 Feb. 2001 15:46:14 GMT”. Since it is contained in an object element with the attributes ns=“emweb” and id=“ewxDate”, this data item corresponds to the first <dynamic> element in the skeleton page file shown above, and to the first <emweb_macro> in the original sample page file.

Note that given the source to a web server that can generate pages with dynamic content, a skilled programmer can alter the server so that it can also generate the skeleton and data version of pages when it is instructed to do so. When and how the browser instructs the server to do so is discussed below. Likewise, the browser may be readily adapted to send separate and independent requests for transmission/retransmission of the skeleton and data files.

Having described how a server can convert a page file into different versions of the page file that can be sent by the server to the browser, the following describes further how the server can periodically update a displayed page without having to repeatedly send it the static content, such as the skeleton file, of the page.

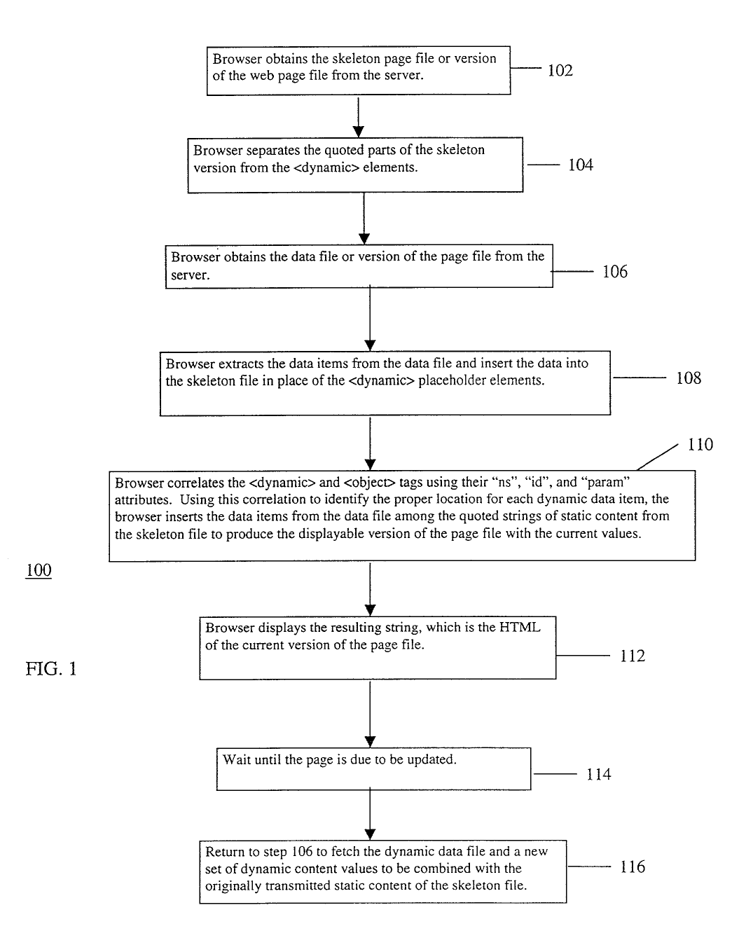

FIG. 1 is a flowchart illustrating one embodiment of an enhanced web page processing and displaying method referenced generally at number 100 incorporating the present invention. In this method, the browser displays and periodically updates the page using the following steps. First, 102, the browser obtains the skeleton version of the page from the server, which has previously converted an original page file into separate files or portions including a skeleton file or otherwise has obtained the skeleton file. Next, 104, the browser separates the quoted parts of the skeleton file from the <dynamic> elements. The browser then obtains the data file or version of the original page file from the server, 106. Next, 108, the browser extracts the data items from the data file and inserts them into the skeleton file in place of the <dynamic> placeholder elements. The browser then, 110, correlates the <dynamic> and <object> tags using their “ns”, “id”, and “param” attributes. Using this correlation to identify the proper location for each dynamic data item, the browser inserts the data items from the data file among the quoted strings of static content from the skeleton file to produce the displayable version of the page with the current values.

As represented as step 112, the browser displays the resulting string, which is the HTML of the current version of the page file. For example:

<!DOCTYPE HTML P UBLIC “-//w3c//DTD HTML 4.01//EN”>
<html>

<head>

<title>Document A</title>
<EMWEB_REFRESH START INTERVAL=“2000”/>

</head>
<body>

<h1>Document A</h1>

These links shouldn't work in prototyping . . . <br />
<a href=“index.html”>index.html</a>
<br />
Mon, 05 Feb 2001 15:46:14 GMT

<table>

<tr><td>Total</td>

<td align=‘right’> 1 345</td>

</tr>
<tr><td>Local Destination</td>

<td align=‘right’>173 768</td>

</tr>
<tr><td>Format Errors</td>

<td align=‘right’> 432</td>

</tr>
<tr><td>Checksum Errors</td>

<td align=‘right’>12 376</td>

</tr>

</table>

</body>

</html>

The next step 114, inserts a “wait” to create a pause until the time the page is due to be updated. It should be understood that other methods of interjecting a refresh periodicity or event are easily adapted into the system. And finally, 116, the browser returns to step 106 to obtain a new set of dynamic content values to be combined with the same static content. It is understood that a skilled programmer can construct software that runs in the web browser to carry out these steps using such powerful “client-side” programming languages as, for example, Java or JavaScript.

The system as described above is further illustrated in the schematic diagram of FIG. 3, wherein exemplary system 200 includes a client 210 that is in communication with a server 230 over a network 240 via communication link(s) 242. The communications network 240/242 may comprise any system for putting devices in electrical communication, including transmitting data between various locations, and may be, include or interface with any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. The communication network may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth, BlueTeeth or WhiteTooth radio link, or an IEEE 802.11 (or Wi-Fi)-based radio frequency link. The communication network may further be, include or interface to any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired/optics (copper, coax, fiber optics, etc.) or wireless, digital or analog interface or connection.

The server 230 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The client 210 may be or include, for instance, a personal computer running the Microsoft Windows™ 95, 98, Millenium™, NT™, 2000 or XP™, Windows™CE™, PalmOS™, Unix, Linux, Solaris™, OS/2™, BeOS™, MacOS™, VAX VMS or other operating system or platform operational in conjunction with processor 218. The client 210 includes electronic cacheable and non-cacheable memory 214 such as RAM (random access memory) or EPROM (electronically programmable read only memory), storage such as a hard drive, CDROM or rewritable CDROM or other magnetic, optical or other media, and other associated components connected over an electronic bus, as will be appreciated by persons skilled in the art. The client 210 further includes a browser and GUI 220 and a refresh module 216 that may be used, for instance in conjunction with server 230, to effect the novel refresh operation described herein. The server 230 is provided with a memory 232 and a refresh module 234 that is used to perform the operations, such as modifying page files, as described herein. As an alternative, a router may take the place of the server to access and transmit web pages, perhaps in conjunction with a server.

Another aspect of the present invention involves a technique for obtaining a new copy of the static portion of the page file, such as included in the skeleton file, when it changes. For example, a page with dynamic content may be or include a table that displays information about a set or group of things. For instance, the page may give information about the interfaces attached to a router. An example of a table is represented as follows:

| Name | Total | Local Dest. | Format Errs. | Checksum Errs. |
|---|---|---|---|---|
| if0 | 1 345 | 173 768 | 143 | 42 |
| if1 | 1 345 | 173 768 | 143 | 42 |
| if2 | 1 345 | 173 768 | 143 | 42 |
| if3 | 1 345 | 173 768 | 143 | 42 |

The HTML to generate this table is:

<!DOCTYPE HTML P UBLIC “-//w3c//DTD HTML 4.01//EN”>
<html>

<head>

<title>Interface statistics</title>

</head>
<body>

<h1>Interface statistics</h1>

<tr><th>Name</th>

<th>Total</th>
<th>Local Dest.</th>
<th>Format Errs.</th>
<th>Checksum Errs.</th>
</tr>

<tr><td>if0</td>

<td>1 345</td>
<td>173 768</td>
<td>143</td>
<td>42</td>

<tr><td>if1</td>

<td>1 345</td>
<td>173 768</td>
<td>143</td>
<td>42</td>

<tr><td>if2</td>

<td>1 345</td>
<td>173 768</td>
<td>143 </td>
<td>42</td>

<tr><td>if3</td>

<td>1 345</td>
<td>173 768</td>
<td>143</td>
<td>42</td>

</tr>

</table>

</body>

</html>

The present invention, as described above, provides a “refreshing” version of this page, with the numbers in the table getting updated or “refreshed” periodically.

But suppose that the set of interfaces in the router changes. (Generally, the set of interfaces will change much more slowly than the statistics displayed on the page.) One way to have the server generate the statistics for a varying set of things or objects is to generate the rows of the table at the time that the server is responding to a request for the page. The page contains an iterator construction that can list all of the interfaces configured into the router at that moment. The input to the server may be represented as follows:

<!DOCTYPE HTML P UBLIC “-//w3c//DTD HTML 4.01//EN”>
<html>

<head>

<title>Interface statistics</title>
</head>
<body>

<h1>Interface statistics</h1>

<tr><th>Name</th>

<th>Total</th>
<th>Local Dest.</th>
<th>Format Errs.</th>
<th>Checksum Errs.</th>
</tr>

<emweb_iterate . . .>

<tr><td><emweb_macro id=‘ifname’ param=emweb:/interface; /></td>

<td><emweb_macro id=‘total’ param=emweb:/interface; /></td>
<td><emweb_macro id=‘local’ param=emweb:/interface; /></td>
<td><emweb_macro id=‘format’ param=emweb:/interface; /></td>
<td><emweb_macro id=‘checksum’ param=emweb:/interface; /></td>
</tr>

</emweb_iterate>

</table>

</body>

</html>

The <emweb_iterate> tag is an iterator that can be readily programmed through program code or the like to cycle through all the interfaces that are currently installed in the router. When the HTML of the page is being output to the browser, the <emweb_iterate> tag is not sent directly to the browser. Rather, it causes the server to repeatedly send the contained HTML, the <tr> containing <td>'s, to the browser, once for each interface. Within the contained HTML, the data items for the row of the table are generated by <emweb_macro>'s. Unlike the previous example, the “param” attribute of the <emweb_macro>'s is not a constant string, but rather is set by the construct “emweb:/interface;”, which, for example, may be programmed to return the name of the interface that is currently being examined by <emweb_iterate>. The <emweb_macro> takes the “param” attribute (the interface name) and looks up the appropriate statistic for that interface.

When generating the skeleton and data versions of the page, the server interprets the <emweb_iterate> as usual, generating multiple repetitions of the skeleton and data versions of the HTML for the row of the table.

The skeleton version of the page with two interfaces will be:

<?xml version=“1.0“?>

<skeleton xmlns=“http://www.emweb.com/xml/skeleton.dtd”><![CDATA[. . .

]]><dynamic ns=‘emweb’ id=‘ifname’ param=‘if0’/><! [CDATA[ . . .

]]><dynamic ns=‘emweb’ id=‘total’ param=‘if0’/><![CDATA[ . . .

]]><dynamic ns=‘emweb’ id=‘local’ param=‘if0’/><! [CDATA[ . . .

]]><dynamic ns=‘emweb’ id=‘format’ param=‘if0’/><! [CDATA[ . . .

]]><dynamic ns=‘emweb’ id=‘checksum’ param=‘if0’/><![CDATA[ . . .

]]><dynamic ns=‘emweb’ id=‘ifname’ param=‘if1’/><![CDATA[ . . .

]]><dynamic ns=‘emweb’ id=‘total’ param=‘if1’/><![CDATA[ . . .

]]><dynamic ns=‘emweb’ id=‘local’ param=‘if0’/><![CDATA[ . . .

]]><dynamic ns=‘emweb’ id=‘format’ param=‘if0’/><![CDATA[ . . .

]]><dynamic ns=‘emweb’ id=‘checksum’ param=‘if1’/><![CDATA[ . . .

(Again the static content has been omitted to emphasize the <dynamic> tags.) The dynamic content version or data file of the page file will appear as follows:

<?xml version=“1.0”?>

<xmlout xmlns=“http://www.emweb.com/xml XMLout.dtd”>

<object ns=‘emweb’ id=‘ifname’ param=‘if0’>if0</object>

<object ns=‘emweb’ id=‘total’ param=‘if0’>1 345</object>

<object ns=‘emweb’ id=‘local’ param=‘if0’>173 768</object>

<object ns=‘emweb’ id=‘format’ param=‘if0’>432</object>

<object ns=‘emweb’ id=‘checksum’ param=‘if0’>12 376</object>

<object ns=‘emweb’ id=‘ifname’ param=‘if1’>if1</object>

<object ns=‘emweb’ id=‘total’ param=‘if1’>1 345</object>

<object ns=‘emweb’ id=‘local’ param=‘if1’>173 768</object>

<object ns=‘emweb’ id=‘format’ param=‘if1’>432</object>

<object ns=‘emweb’ id=‘checksum’ param=‘if1’>12 376</object>

</xmlout>

These versions of the page file look as they do because they are created as modifications of the original page file. The <emweb_iterate> is processed as normal, causing the <emweb_macro> tags to be processed multiple times. Each processing of <emweb_macro> generates a <dynamic> tag in the skeleton file and an <object> tag in the dynamic file.

The process described in the previous section will correctly combine the dynamic file with the skeleton file and produce the proper HTML to display the desired table of information. At the set interval, the browser will fetch a refreshed version of the dynamic file content and insert the refreshed data fields into or otherwise combine with the skeleton file to create a refreshed HTML for the table containing the new data.

In the event an additional interface is added to the router, the next fetch of the dynamic file content will produce a file having more <object> tags than before, for example:

<?xml version=“1.0”?>

<xmlout xmlns=“http://www.emweb.com/xml/XMLout.dtd”>

<object ns=‘emweb’ id=‘ifname’ param=‘if0’>if0</object>

<object ns=‘emweb’ id=‘total’ param=‘if0’>1 345</object>

<object ns=‘emweb’ id=‘local’ param=‘if0’>173 768</object>

<object ns=‘emweb’ id=‘format’ param=‘if0’>432</object>

<object ns=‘emweb’ id=‘checksum’ param=‘if0’>12 376</object>

<object ns=‘emweb’ id=‘ifname’ param=‘if1’>if1</object>

<object ns=‘emweb’ id=‘total’ param=‘if1’>1 345</object>

<object ns=‘emweb’ id=‘local’ param=‘if1’>173 768</object>

<object ns=‘emweb’ id=‘format’ param=‘if1’>432</object>

<object ns=‘emweb’ id=‘checksum’ param=‘if1’>12 376</object>

<object ns=‘emweb’ id=‘ifname’ param=‘if2’>if2</object>

<object ns=‘emweb’ id=‘total’ param=‘if2’>1 345</object>

<object ns=‘emweb’ id=‘local’ param=‘if2’>173 768</object>

<object ns=‘emweb’ id=‘format’ param=‘if2’>432</object>

<object ns=‘emweb’ id=‘checksum’ param=‘if2’>12 376</object>

</xmilout>

Since this document contains values for all of the <dynamic> tags in the skeleton file, it would be possible to use it for generating updated HTML. But that HTML would be a table with only two rows, which would not be an accurate reflection of the status of the router. However, by comparing or otherwise analyzing page file related data, the browser or server can detect that there is a mismatch between the two versions of the page file. The collection of <object> tags in the dynamic file does not match the collection of <dynamic> tags in the skeleton file when they are matched based on their “ns”, “id”, and “param” attributes. This gives an indication that the browser needs to re-fetch the skeleton file or version of the page file because the original page file has changed and the corresponding skeleton file would change.

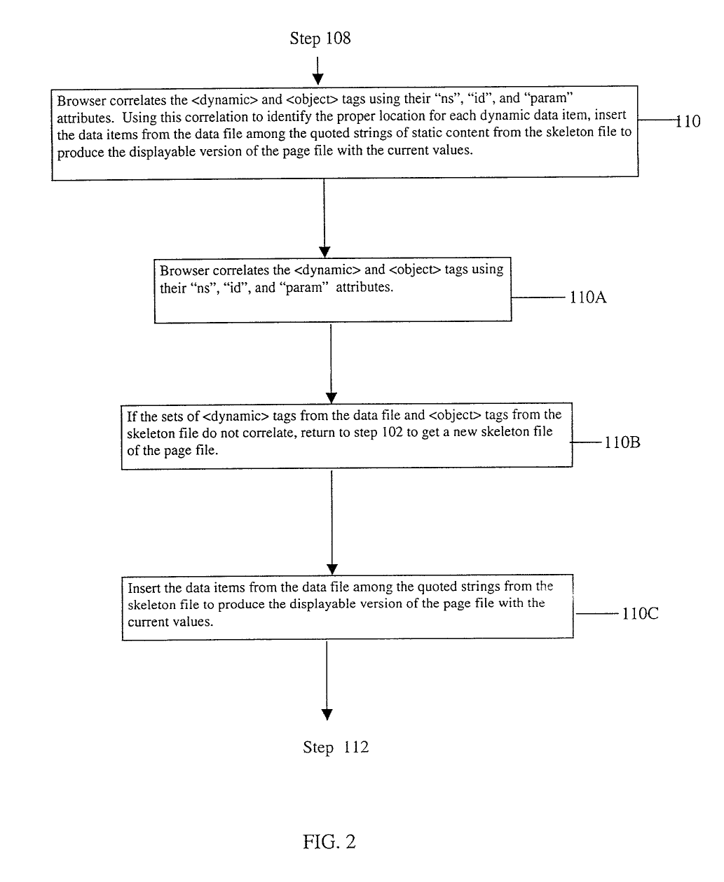

One manner to re-fetch the skeleton file of the page when necessary is illustrated in the sub-routine of FIG. 2, which is essentially a modification of step 110 of the method of FIG. 1. The sub-routine includes the following additional steps. The browser correlates the <dynamic> and <object> tags using their “ns”, “id”, and “param” attributes, 110A. If the sets of <dynamic> tags from the data file and <object> tags from the skeleton file do not correlate or match, the browser returns to step 102 to get a new skeleton version of the page file, 110B. And finally, 110C, the browser inserts the data items from the data file among the quoted strings from the skeleton file to produce the displayable version of the page file with the current values.

This method allows a dynamically refreshable page whose structure changes, as well as one whose data item(s) changes. It requires no intervention by the viewer to signal that the structure of the page file has changed, and no coding on the part of the page designer to explicitly cause the browser to watch for a change in the structure of the page file.

Another aspect of the present invention involves combining graphical user interface (GUI) modules or “widgets” with HTML. In addition to the automatic and improved refresh features described above, the present invention provides a GUI that enhances HTML by adding one or more HTML GUI related modules or “widgets”. In one manner, from the user/client perspective, the HTML GUI modules act as additional HTML features, in that they are included inside the HTML file of a page and contain within themselves sections of HTML. In this way, HTML GUI modules are like the <table> element of HTML, which organizes a set of HTML fragments into a table structure, and itself acts like an HTML fragment.

However, unlike <table>, which is implemented directly by the browser, the code which implements GUI in the browser: finds each HTML GUI module; finds the HTML GUI module HTML contents; assembles the HTML which implements the HTML GUI module (with the contained HTML fragments); and incorporates the HTML from the GUI HTML module into the rest of the HTML for the page. In this manner, pages that use GUI HTML modules are specified as XML documents, with the HTML GUI modules specified as XML elements. The rest of the page, the HTML, is given as quoted strings (CDATAs). For instance, a <tabbar> on a page may be used in the following way to generate a “tab bar” (a set of alternative panes that can be selected by clicking on “tabs” which appear above the displayed pane):

<?xml version=“1.0”?>
<CONTENT BGCOLOR=‘white’>
<![CDATA[
<big>
<strong>
EmWeb GUIkit Tabbar Template
</strong>
</big>
<hr></hr>
<p>
When you use a tabbar HTML module, you can organize several pages of Web
content into a single page, using the tabs to display the different
pages.
</p>
]]>
<TABBAR BORDER=‘1’ WIDTH=‘300’ HEIGHT=‘300’>

<TABITEM NAME=“Page1”>

<TEXT>Page 1</TEXT>
<CONTENT>
<![CDATA[
<center><p> This would contain the Web content for Page 1. </p> </center>
]]>
</CONTENT>

</TABITEM>
<TABITEM NAME=“Page2”>

<TEXT>Page 2</TEXT>
<CONTENT>
<![CDATA[
<center><p>The Web content for Page 2 would appear here.</p></center>
]]>
</CONTENT>

</TABITEM>
<TABITEM NAME=“Page3”>

<TEXT>Page 3</TEXT>
<CONTENT>
<![CDATA[
<center><p> Page 3 Web content goes here, and so on . . . </p></center>
]]>
</CONTENT>

</TABITEM>

</TABBAR>
</CONTENT>

Suppressing the content of the CDATAs better illustrates the structure of the XML document, as follows:

<?xml version=“1.0”?>
<CONTENT BGCOLOR=‘white’>
<![CDATA[ . . . ]]>
<TABBAR BORDER=‘1’ WIDTH=‘300’ HEIGHT=‘300’>

<TABITEM NAME=“Page1”>

<TEXT>Page 1</TEXT>
<CONTENT>
<![CDATA[ . . . ]]>
</CONTENT>

</TABITEM>
<TABITEM NAME=“Page2”>

<TEXT>Page 2</TEXT>
<CONTENT>
<![CDATA[ . . . ]]>
</CONTENT>

</TABITEM>
<TABITEM NAME=“Page3”>

<TEXT>Page 3</TEXT>
<CONTENT>
<![CDATA[ . . . ]]>
</CONTENT>

</TABITEM>
</TABBAR>
</CONTENT>

The organization of the file keeps the pieces of ordinary HTML inside CDATA sections (which are quoted strings). This allows processing by the following method:

1. Parse the document as XML. (The fragments of HTML are treated as un-interpreted strings.).

2. Expand the XML tags into HTML appropriately, possibly inserting into the generated HTML the HTML in the contained CONTENT elements. The TABBAR element, and its contained TABITEM and TEXT elements, together form a structure which is expanded into the HTML needed to display the “tab bar”. This structure includes several fill-in-the-blank holes into which the contents of the contained CONTENT elements are inserted. In this example, the CONTENT elements are just wrappers for contained HTML, but in general they can contain HTML modules which are expanded to produce HTML. It is the expanded version of the CONTENT elements which is inserted into the HTML generated by the TABBAR element.

3. Once the HTML modules are turned into HTML, the result is an HTML document, which can be handed to the browser for display.

It is understood that a skilled programmer can implement these methods in the browser using a client-side language, for example Java or JavaScript.

In a further aspect of the present invention, an improved system and method are provided to specify GUI HTML modules in web pages. This method eliminates the need for separating the HTML parts of the page from the XML representing the HTML modules using CDATAs, as discussed in the example above. One feature of the invention is to allow the user to write the exemplary embodiment discussed above in the following much simpler form:

<?xml version=“1.0”?>
<GUIkit:CONTENT BGCOLOR=‘white’

GUIkit:xmlns=“http://emweb.com/GUIkit.dtd”>

<big>
<strong>
EmWeb GUIkit Tabbar Template
</strong>
</big>
<hr/>
<p>

A tabbar HTML module permits the system to organize several pages of Web content into a single page, using the tabs to display the different pages. For example:

</p>

<GUIkit:TABBAR BORDER=‘1’ WIDTH=‘300’ HEIGHT=‘300’>

<GUIkit:TABITEM NAME=“Page1”>

<GUIkit:TEXT>Page 1</GUIkit:TEXT>
<GUIkit:CONTENT>
<center><p> This would contain the Web content for Page 1. </p> </center>
</GUIkit:CONTENT>

</GUIkit:TABITEM>
<GUIkit:TABITEM NAME=“Page2”>
<GUIkit:TEXT>Page 2</GUIkit:TEXT>
<GUIkit:CONTENT>

<center><p>The Web content for Page 2 would appear here.</p></center>

</GUIkit:CONTENT>

</GUIkit:TABITEM>
<GUIkit:TABITEM NAME=“Page3”>

<GUIkit:TEXT>Page 3</GUIkit:TEXT>
<GUIkit:CONTENT>
<center><p> Page 3 Web content goes here, and so on....</p></center>
</GUIkit:CONTENT>

</GUIkit:TABITEM>

</GUIkit:TABBAR>
</GUIkit:CONTENT>

This format treats the GUI HTML modules in the same way as HTML elements. In one manner to achieve this functionality, adaptations are needed, both in how the user writes the contents of the page and in the processing that the GUI uses to turn the page into HTML for display by the browser. That is, for example, the HTML that the user writes should be understandable by the parser that is locating the GUI HTML module elements. One straightforward way to do this is to write HTML in a way that is conformant to XML rules, and then use an XML parser to parse the entire document, both the HTML and the HTML modules. Writing HTML in a way that is also valid XML has been standardized in the language known as XHTML. In the example above, the HTML has been written according to XHTML rules. Further, a method may be employed to identify the GUI elements in a way that will not conflict with HTML (XHTML) elements. One straightforward way to do this is to use the namespace mechanism in XML to mark the GUI HTML module elements with a special “namespace” that identifies them. In the example above, the namespace prefix “GUIkit” has been used to identify GUI HTML module elements.

It is understood that a skilled programmer could design a number of different ways of organizing the input page to achieve these results. These techniques can be implemented via the browser using, for example, either Java or JavaScript.

Another aspect of the present invention involves the use of suffixes to specify special modes for serving pages. In implementing aspects of the invention discussed above, a mechanism may be provided to enable the browser to inform the server to deliver a page to the browser in a different manner than the server normally uses. Additionally, since the delivered pages will be processed in the browser by client-side programming, program code written in the client-side language should be able to make requests that activate the special modes. The browser communicates with the server in a fairly rich manner. Information in requests that can be easily manipulated by client-side code is the URL that is used to request the page. So, it is useful to specify some modification that is applied to the URL for a page in order to request that the data or skeleton file be sent to the browser. There are a number of ways to modify a URL. However, practical requirements rule out many possibilities.

One requirement is that the modification be applied to the “path” part of the URL. For instance, an example of a fully formed URL is: http://www.example.com/p1/p2/p3/p4.html?var=value. The components of the URL are as follows: “http://www.example.com” is the “authority” part and includes the “scheme” or communication protocol, “http”, that is to be used to retrieve the document and the name of the server, “www.example.com”, that is to be contacted to obtain the page. “/p1/p2/p3/p4.html” is the “path” part and identifies the page on the server. “var=value” is an additional “query” part and specifies additional information for the page, which may use that information to adjust what contents will be provided.

Modifying the authority part may not be practical because it specifies directly the name of the server computer from which to obtain the page. Modifications to the authority part would direct the browser's request to a different server than the one containing the page of interest. Another practical problem is that in some circumstances the browser adds its own query part to URLs. This is particularly so when submitting a form to the server. So it is difficult to specify an addition or modification of a query part without being interfered with when a browser adds its own query part.

Another requirement is to be able to specify modified URLs in links from other pages: For our purposes, links may be either “relative” or “absolute”. An absolute link specifies the path part of the URL directly, e.g.,: <A HREF=“/p1/p2/p3/p4.html”>. A relative link specifies the path part based on the path part of the URL of the page that contains the link. If the page “/p1/p2/p3/p4.html” contains the relative link: <A HREF=“q1/q2.html”>, then the link specifies the URL with the path part “/p1/p2/p3/q1/q2.html”—the path part of the containing URL is truncated at the last “/”, and then the relative link is appended.

Because of the logic of processing relative links, it may not be desirable to specify the URL modifier as a prefix of the path part. It may be highly difficult to specify the modifier prefix in a relative link, because the beginning of the linked-to URL is the beginning of the URL of the page containing the link.

A further requirement is that the modification should be something that will not be triggered accidentally when a user writes a URL without intending to specify the special processing mode. This need may require compromises, since any possible URL might be encountered accidentally. Two exemplary ways to reduce the probability of such an accident are: having the modification contain a combination of characters that is not commonly used in URLs, and having the modification contain a trademark or other identifier which has a narrow and specific usage.

This aspect of the invention satisfies the above needs. The invention may specify special processing modes by appending a suffix to the path part of the URL. In the EmWeb implementation, the suffixes start with the string “!!EmWeb!!”, followed by one or more letters to specify the special processing mode. For instance: 1) the skeleton version of a page file is obtained by appending “!!EmWeb !!S” to the path part of the URL; and 2) the data version of the page file is obtained by appending “!!EmWeb !!X” to the path part of the URL. Thus, if the browser wants to obtain the skeleton version of the page file “http://www.example.com/p1/p2/p3/p4.html” it requests “http://www.example.com/p1/p2/p3/p4.html!!EmWeb!!S”.

The particular form of the suffix, “!!EmWeb!! . . . ” is chosen to minimize the chance that such a URL would be created accidentally. The exclamation mark is a very uncommon character in URLs and “EmWeb” is a registered trademark of Virata Corp. for its web server for embedded systems.

While the foregoing description includes many details and specificities, it is to be understood that these have been included for purposes of explanation only, and are not to be interpreted as limitations of the present invention. Many modifications to the embodiments described above can be made without departing from the spirit and scope of the invention. The specification should be considered exemplary only, and the scope of the invention is accordingly intended to be limited only by the following claims and equivalents thereof.

What is claimed is:

1. A method for refreshing the display of a web page on a client computer, the client computer having a memory, a browser and a display, the client computer receiving at least one page file associated with the displayed web page from a server connected to the client computer via a communication link over a distributed network, the method comprising the steps of:
requesting by the client computer a web page from the server;
obtaining by the server one or more page files associated with the requested web page;
modifying by the server at least one page file comprising static and dynamic data fragments into a skeleton file comprising static data and a dynamic data file representing dynamic data;
transmitting by the server to the client computer at least the skeleton file and the dynamic data file;
adapting by the client browser at least the skeleton file and the dynamic data file to display the web page associated with the modified page file; and
the server retransmitting the dynamic data file while not retransmitting the skeleton file to the client to refresh the displayed web page with changed dynamic data.

2. The method of claim 1, further comprising the step of:
modifying a URL by the client to specify a special mode for receiving served pages, the special mode instructing the server to modify the at least one page file into the skeleton file and the dynamic data file and to serve the skeleton file and dynamic data file to the client.

3. The method of claim 2, wherein the client modifies the path portion of the URL to specify the special mode.

4. The method of claim 2, wherein the client modifies the URL by appending a suffix to the path portion of the URL.

5. The method of claim 4, wherein a first suffix represents the skeleton file and a second suffix represents the dynamic data file.

6. The method of claim 2, wherein the URL is modified to specify a special mode by using characters not commonly found in URLs.

7. The method of claim 2, wherein a first modification represents the skeleton file and a second modification represents the dynamic data file.

8. In a distributed network comprising at least one server and at least one client computer in electrical communication with the at least one server via a communications link, a system for modifying page files associated with web pages for display at the client computer to achieve more efficient refreshing of displayed web pages, the system comprising:
a refresh module stored on a memory accessible by a server and executable by a server processor, the server receiving a request from a client computer for a web page to be displayed at the client computer, the server obtaining at least one page file associated with the web page and providing the page file to the refresh module, the refresh module adapted to modify the page file to generate a skeleton file comprising static content and placeholders for dynamic data, and a dynamic data file comprising data identified to change over time; the server transmitting the skeleton file and the dynamic data file to the client;
the client computer comprising an input for receiving the skeleton file and the dynamic data file from the server over the communications link;
the client computer further comprising a browser adapted to combine the skeleton file with the dynamic data file in generating and displaying the requested web page;
wherein the system is adapted to subsequently retransmit the dynamic data file while not retransmitting the skeleton file to refresh the dynamic data associated with the requested and displayed web page.

9. The system of claim 8, wherein the client is further adapted to modify a URL to specify a special mode for receiving served pages, the special mode instructing the server to modify the at least one page file into the skeleton file and the dynamic data file and to serve the skeleton file and dynamic data file to the client.

10. The system of claim 9, wherein the client modifies the path portion of the URL to specify the special mode.

11. The system of claim 9, wherein the client modifies the URL by appending a suffix to the path portion of the URL.

12. The system of claim 11, wherein a first suffix represents the skeleton file and a second suffix represents the dynamic data file.

13. The system of claim 9, wherein the URL is modified to specify a special mode by using characters not commonly found in URLs.

14. The system of claim 9, wherein a first modification represents the skeleton file and a second modification represents the dynamic data file.

15. The system of claim 8 wherein the client computer is adapted to request retransmission of the dynamic data file while not requesting retransmission of the skeleton file to refresh the dynamic data file associated with the requested and displayed web page.

16. The system of claim 8 wherein the client computer further comprises a cache memory for storing the skeleton file and a non-cache memory for storing the dynamic data file.

17. For use in a distributed network comprising at least one server having a processor and a memory and being in electrical communication with at least one client computer over a communications link, a computer readable medium comprising a set of executable instructions stored on the server memory and being machine readable by and adapted to manipulate the server processor to cause the server to perform a plurality of functions, the functions comprising:
obtaining from a memory at least one page file associated with a web page requested by the client, the page file comprising both static and dynamic data;
modifying the page file to generate a skeleton file comprising static data and having markers for dynamic data associated with the web page;
modifying the page file to generate a dynamic data file comprising dynamic data associated with the web page;
recognizing a request for updated dynamic data; and
retransmitting the dynamic data file to the client to refresh dynamic data of the web page displayed at the client.

18. In a distributed network comprising a first computer and having stored therein an HTML file comprising static data and dynamic data, the first computer being in electrical communication with a second computer over the network and transmitting thereto data representative of the HTML file for displaying a web page at the second computer, a system for updating the dynamic data portion of the HTML file without updating the static portion of the HTML file cached at the second computer to achieve more efficient refreshing of the displayed web page, the system comprising:
a refresh module stored and executable at the first computer and adapted to modify the HTML file to generate a skeleton file comprising static content and placeholders for dynamic data, and a dynamic data file comprising data identified to change over time;
the first computer being adapted to transmit the skeleton file and the dynamic data file to the second computer;
the second computer being adapted to receive the skeleton and dynamic data files;
a browser operable on the second computer and being adapted to combine the skeleton file with the dynamic data file to generate and display a web page associated with the HTML file;
the first computer subsequently retransmitting the dynamic data file while not retransmitting the skeleton file to refresh dynamic data associated with the HTML file and the displayed web page.

19. The system of claim 18, wherein the browser is adapted to modify a URL to specify a special mode for receiving pages, the special mode instructing the first computer to modify the at least one page file into the skeleton file and the dynamic data file and to send the skeleton file and dynamic data file to the second computer.

20. The system of claim 19, wherein the browser modifies the path portion of the URL to specify the special mode.

21. The system of claim 19, wherein the browser modifies the URL by appending a suffix to the path portion of the URL.

22. The system of claim 21, wherein a first suffix represents the skeleton file and a second suffix represents the dynamic data file.

23. The system of claim 19, wherein the URL is modified to specify a special mode by using characters not commonly found in URLs.

24. The system of claim 19, wherein a first modification represents the skeleton file and a second modification represents the dynamic data file.

25. The system of claim 18 wherein the second computer is adapted to request retransmission of the dynamic data file while not requesting retransmission of the skeleton file to refresh the dynamic data file associated with the requested and displayed web page.

26. The system of claim 18 wherein the second computer further comprises a cache memory for storing the skeleton file and a non-cache memory for storing the dynamic data file.

27. (refreshing static content) A method for refreshing the display of a web page on a client computer having a memory, a browser and a display, the client receiving page files associated with the displayed web page from a server connected to the client computer via a communication link over a distributed network, the method comprising the steps of:
requesting from the client computer a web page from the server;
obtaining by the server page files associated with the requested web page;
modifying by the server at least one page file comprising static and dynamic data fragments into a skeleton file comprising static data and a dynamic data file representing dynamic data;
transmitting by the server to the client at least the skeleton file and the dynamic data file;
processing by the browser at least the skeleton file and the dynamic data file to display the web page associated with the modified page file;
subsequently retransmitting by the server a refreshed dynamic data file while not retransmitting the skeleton file to the client to refresh the displayed web page with updated dynamic data;
determining that a change in the content of the skeleton file has occurred; and
transmitting by the server to the client a revised skeleton file representing the change in content for replacing the skeleton file and for storing the revised skeleton file at the client.

28. The method of claim 27 wherein the skeleton file includes at least one tag of a first type representative of dynamic data and the dynamic data file includes at least one tag of a second type representative of dynamic data, and wherein the step of determining a change in skeleton file content comprises the steps of:
comparing tags of the first type contained in the skeleton file with tags of the second type contained in the dynamic data file; and
detecting a lack of correlation between the tags of the first type and the tags of the second type.

29. The method of claim 28 wherein the determining step is carried out at the client computer by comparing the tags of the refreshed dynamic data file with the tags of the skeleton file stored in cache memory.

30. The method of claim 28 wherein the tags of the first type and tags of the second type include at least one attribute and the step of comparing the tags is accomplished by comparing the number of occurrences of tags having the attribute.

31. (refreshing static content) In a distributed network comprising at least one server and at least one client computer in electrical communication with the at least one server via a communications link, a system for modifying page files associated with web pages for display at the client computer to achieve more efficient refreshing of displayed web pages, the system comprising:
a refresh module stored on a memory accessible by a server and executable by a server processor, the server receiving a request from a client computer for a web page to be displayed at the client computer, the server obtaining at least one page file associated with the web page and providing the page file to the refresh module, the refresh module adapted to modify the page file to generate a skeleton file comprising static content and placeholders for dynamic data, and a dynamic data file comprising data identified to change over time; the server transmitting the skeleton file and the dynamic data file to the client;
the client computer having an input for receiving the skeleton file and the dynamic data file from the server over the communications link;
the client further comprising a browser adapted to combine the skeleton file with the dynamic data file in generating and displaying the requested web page; and
wherein the system is adapted to subsequently retransmit the dynamic data file while not retransmitting the skeleton file to refresh the dynamic data associated with the requested and displayed web page;
the system being further adapted to determine a change in the content of the skeleton file and to transmit to the client a revised skeleton file representing the change in content for replacing the skeleton file and for storing the revised skeleton file at the client.

32. The system of claim 31 wherein the skeleton file includes at least one tag of a first type representative of dynamic data and the dynamic data file includes at least one tag of a second type representative of dynamic data, and wherein the system is adapted to compare tags of the first type contained in the skeleton file with tags of the second type contained in the dynamic data file to detect a lack of correlation between the tags of the first type and the tags of the second type.

33. The system of claim 32 wherein the client computer is adapted to compare the tags of the refreshed dynamic data file with the tags of the skeleton file stored in cache memory.

34. The system of claim 32 wherein the tags of the first type and tags of the second type include at least one attribute and the system is adapted to compare the number of occurrences of tags having the attribute.

35. The system of claim 31 wherein the client computer is adapted to request retransmission of the dynamic data file while not requesting retransmission of the skeleton file to refresh the dynamic data file associated with the requested and displayed web page.

36. The system of claim 31 wherein the client computer further comprises a cache memory for storing the skeleton file and a non-cache memory for storing the dynamic data file.

37. In a distributed network comprising a server serving an XHTML file to a client computer over a communications link, the client comprising a browser and GUI, a method of converting the XHTML file into an HTML file for displaying a requested web page, the method comprising the steps of:
assigning, using the namespace mechanism in XML, a namespace to mark at least one GUI HTML module contained in the XHTML file;
parsing the XHTML file to locate GUI HTML module; and
assembling the HTML file by the browser, including the GUI HTML module, to display a requested web page.

38. The method of claim 37 wherein the GUI HTML module contains HTML fragments that are included in the displayed web page.

39. In a distributed network having a server serving an XHTML file to a client computer over a communications link, the client having a browser and GUI, a method of converting the XHTML file into an HTML file for displaying a requested web page, the method comprising the steps of:
assigning, using the namespace mechanism in XML, a namespace to mark at least one GUI XML element contained in the XHTML file;
parsing the XHTML file to locate a GUI XML element;
converting the GUI XML element into an HTML template which instructs the browser to perform actions intended by the GUI XML element;
replacing the GUI XML element within the XHTML file with the HTML template; and
displaying the resulting HTML file by the browser, resulting in displaying the requested web page.

40. The method of claim 39 wherein the GUI XML element contains HTML fragments that are included in the displayed web page.
